(19) United States
(12) Patent Application Publication
(10) Pub. No.: US 2011/0063600 A1
(43) Pub. Date: Mar. 17, 2011

(54) FILM HOLDER

(75) Inventors: Xian-Jun Wang, Suzhou (CN); Ming-Jie Zhao, Suzhou (CN); Jian-Chun Yu, Suzhou (CN)

(73) Assignee: QISDA (SUZHOU) CO., LTD, Suzhou (CN)

(21) Appl. No.: 12/794,709

(22) Filed: Jun. 4, 2010

(30) Foreign Application Priority Data
Sep. 12, 2009 (CN) 200920169693.1

(51) Int. Cl. G03B 27/62; H04N 5/253

(52) U.S. Cl. 355/75; 348/96

(57) ABSTRACT

A film holder is provided. During scanning of a to-be-scanned object, the film holder is inserted into a scanning device. The film holder includes an input portion, a guiding portion and an information window. The input portion has an entrance, a channel and an exit, the channel disposed between the entrance and the exit. During scanning of the to-be-scanned object, the to-be-scanned object passes through the channel. The guiding portion connects to the input portion for guiding the to-be-scanned object. The information window is formed at and through the guiding portion. During scanning of the to-be-scanned object, the side regions of the to-be-scanned object pass through the information window. Functions of the scanning device are effectively augmented; the film is kept from being scratched; the quality of image scanning is kept from being deteriorated; and it is convenient to use the scanning device.

This application claims the benefit of People's Republic of China application Serial No. 200920169693.1, filed Sep. 12, 2009 the subject matter of which is incorporated herein by reference.

### TECHNICAL FIELD

The invention relates in general to a film holder, and more particularly to a film holder which is adapted in a film scanning device and has an information window.

### BACKGROUND

Nowadays, various image scanning devices have been widely used in work or everydayness. Examples of the image scanning devices include flatbed scanners or portable scanners with film scanning function, or apparatus capable of converting films, such as positives, negatives, slides and reversal films, into electronic files/images. During scanning of a film, the user normally places the film into a film holder and loads the film holder into the scanning device; and scanning of the film is completed via a drive device and a light source.

During scanning, logic judgments regarding the type and the disposition of the scan film are made. The alphabetic information on the two lateral sides of the film is read for optical recognition. The alphabetic information includes film code, DX code, and the digits, the brand and the marks printed on the film. However, in prior art, the film carrying portion of the film holder will block the above alphabetic information and impede function augmentation of the scanning device, and cause inconvenience to the user.

### BRIEF SUMMARY

To resolve the above technological problems, in embodiments of the invention, an information window is formed on and through the film holder, so that the alphabetic information or the film primary color on the lateral side of the film lateral is fully used, and the function is augmented.

A film holder is provided. During scanning of a to-be-scanned object, the film holder is inserted into a scanning device. The film holder includes an input portion, a guiding portion and an information window. The input portion has an entrance, a channel and an exit, the channel disposed between the entrance and the exit. During scanning of the to-be-scanned object, the to-be-scanned object passes through the channel. The guiding portion connects to the input portion for guiding the to-be-scanned object. The information window is formed at and through the guiding portion. During scanning of the to-be-scanned object, the side regions of the to-be-scanned object pass through the information window.

According to the film holder of embodiments of the invention, the information window includes a via hole intersecting the guiding portion. Furthermore, the via hole is a closed hole disposed in the guiding portion, or a semi-closed hole disposed on one side of the guiding portion.

Furthermore, the via hole is anyone of a circle, an ellipse, a rectangle and a trapezoid or a combination thereof.

According to the film holder of embodiments of the invention, a slide boosting coating is formed on the guiding portion. In greater details, the slide boosting coating is realized by a PTFE (PTFE) coating.

According to the film holder of embodiments of the invention, the guiding portion includes two opposite guiding slots. The side regions of the to-be-scanned object are received in the two guiding slots, respectively. The image region of the to-be-scanned object is located between the two guiding slots. The guiding slot and the channel are interconnected.

According to the film holder of embodiments of the invention, the input portion includes an incoming surface and the upper cover; the incoming surface is disposed at the entrance and is further extended to the channel surrounded by the upper cover and the incoming surface. Furthermore, the input portion further includes a protrusion disposed on the upper cover. When the film holder is inserted into the scanning device, the protrusion leans against the scanning device.

The film holder of embodiments of the invention further includes a blocker disposed at one end of the guiding portion far away from the input portion. The blocker has a bevel. When the film holder is inserted into the scanning device, the bevel leans against the scanning device.

By embodiments of the invention, the optical recognition function of the scanning device is effectively augmented; and it is convenient to use the scanning device.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a schematic diagram of a film holder according to an embodiment of the invention;

FIG. 2 shows a schematic diagram of a film holder according to another embodiment of the invention; and

FIG. 3 shows operations of the film holder according to the embodiment of the invention.

### DETAILED DESCRIPTION OF EXEMPLARY EMBODIMENT OF THE INVENTION

The objects, structures, characteristics and functions of embodiments of the invention are disclosed below with accompanying drawings.

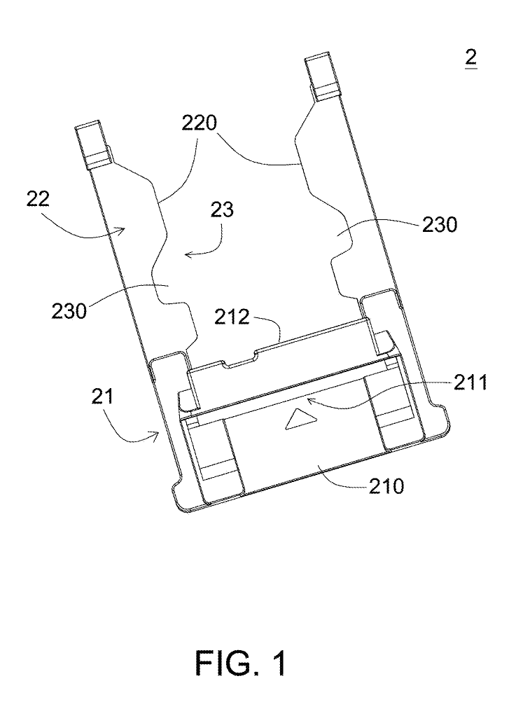

An embodiment of the invention provides a film holder for carrying a to-be-scanned film. The film includes an image region and two side regions. The side region includes tooth holes and some alphabetic information such as the film code, DX code and the digits, the brand and the marks printed on the film. The side regions further show the primary color of the film. During scanning of a film, the film holder is inserted into the scanning device. Referring to FIG. 1, a schematic diagram of a film holder 2 according to an embodiment of the invention is shown. The film holder 2 includes an input portion 21, a guiding portion 22 and an information window 23. The input portion 21 has an entrance 210, a channel 211 and an exit 212, the channel 211 disposed between the entrance 210 and the exit 212. During scanning of the film, the film passes through the channel 211. The guiding portion 22 connects to the input portion 21 for guiding the side region of the film. For example, the guiding portion 22 is disposed at the exit 212, but the invention is not limited thereto. In practical application, the guiding portion 22 may includes two opposite guiding slots 220, in which the side regions of the film are received, respectively. The image region of the film is located between the two guiding slots 220. The guiding slots 220 and the channel 211 are interconnected. In an embodiment, to avoid the film being scratched when sliding in the guiding portion 22, a slide boosting layer is formed on the guiding portion 22. In greater details, the slide boosting coating is realized by a PTFE layer. The information window 23 is formed at and through the guiding portion 22. During scanning of the film, the side regions of the film pass through the information window 23. The side region could be disposed at the left side and the right side of the image region, or disposed at the top side and the bottom side of the image region. The position of the information window 23 in the guiding portion 22 may be changed without departing from the broad inventive concept thereof, as long as during scanning, the to-be-recognized information of the side regions of the film pass through the information window.

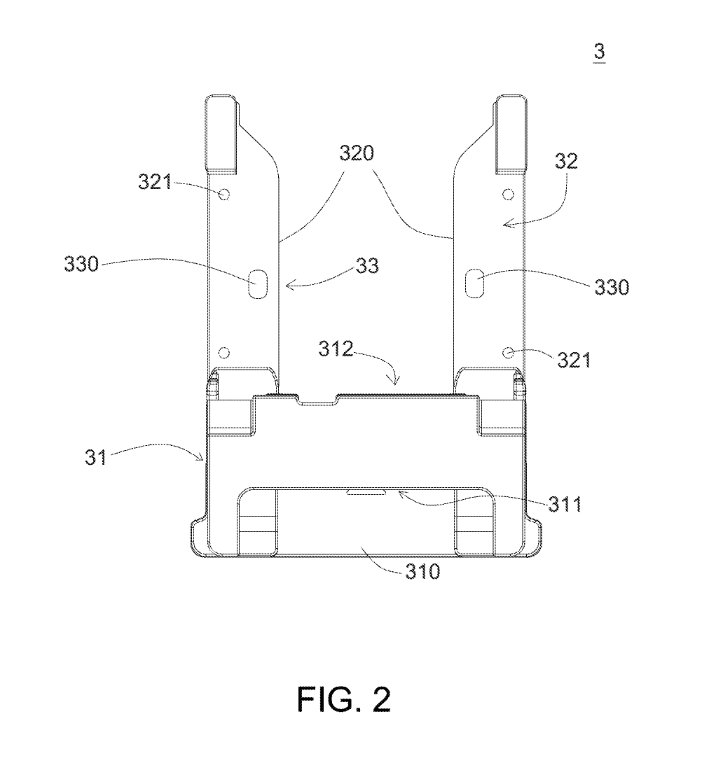

In the embodiment, the information window 23 includes via holes 230 intersecting the guiding portion 22. As indicated in FIG. 2, the via hole 230 is semi-closed and disposed on one side of the guiding portion 22. However, the a semi-closed via hole would make the film come off from the via hole 230. Also, due to the design of tooth hole on the film, motion blur may occur during image scanning.

To resolve the above problem, a film holder with new design is provided in another embodiment of the invention. Referring to FIG. 2, a schematic diagram of a film holder 3 according to another embodiment of the invention is shown. The film holder 3 includes an input portion 31, a guiding portion 32 and an information window 33. The input portion 31 has an entrance 310, a channel 311 and an exit 312, the channel 311 disposed between the entrance 310 and the exit 312. During scanning of the film, the film 30 passes through the channel 311. The guiding portion 32 connects to the input portion 31 for guiding the film. The information window 33 is formed at and through the guiding portion 32. During scanning of the film, the side regions of the film pass through the information window 33. For the same elements in the present embodiment of FIG. 2 and in the embodiment of FIG. 1, the same designations are used and the similarities are not repeated here. The present embodiment is different the above embodiment in that the via hole 330 of the information window 33 is a closed hole and disposed in the guiding portion 32. In practical application, the via hole 330 is anyone of a circle, an ellipse, a rectangle and a trapezoid or a combination thereof. The via hole 330 is different from the positioning hole formed during the manufacturing process. For example, the positioning hole 321 of FIG. 2 is formed for positioning the film holder during the manufacturing process, and does not have any practical function during image scanning. In other possible embodiment of the invention, positioning holes located at suitable location can be used as an information window, without departing from the broad inventive concept thereof, as long as the to-be-recognized information on the side regions could pass through the information window during scanning.

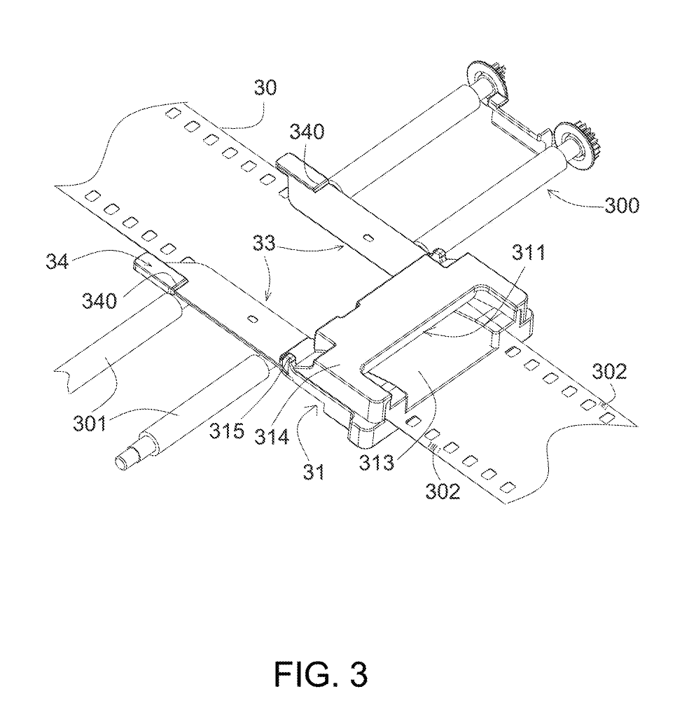

Referring to FIG. 3, a diagram of operations of the film holder 3 according to the embodiment of the invention is shown. The following descriptions on the film holder are also applicable to the film holder (such as the film holder 2) of other embodiments. During scanning of the film, the film 30 passes through the channel 311. The input portion 31 includes an incoming surface 313 and an upper cover 314, wherein the incoming surface 313 is disposed at the entrance of the input portion 31 and is further extended to the channel 311. The channel 311 is surrounded by the upper cover 314 and the incoming surface 313. In other possible embodiment, in order to increase the friction between the film 30 and the driving roller 301 inside the scanning device 300 so that the driving roller 301 can easily drive the film 30 to move, the input portion 31 further includes one or more protrusions 315 disposed on the upper cover 314. When the film holder 3 is inserted into the scanning device 300, the protrusion or the protrusions 315 lean against the scanning device 300. For example, the protrusion or the protrusions 315 lean against the housing (not illustrated in FIG. 3) of the scanning device 300.

The film holder 3 further includes a blocker 34 disposed at one end of the guiding portion 32 far away from the input portion 31. The blocker 34 has a bevel 340. When the film holder 3 is inserted into the scanning device 300, the bevel 340 leans against the scanning device 300. For example, the bevel 340 leans against the passive roller inside the scanning device 300, so that the passive roller (not illustrated in FIG. 3) and the bevel 340 generate a pushing force for achieving element positioning and increasing the hand feeling.

The information window 33 is formed at and through the guiding portion 32. During scanning of the film, the alphabetic information 302 on the side regions of the film 30 passes through the information window 33. The alphabetic information 302 on the two lateral sides of the film 30 is read by the sensing element of the scanning device 300 for optical recognition. The alphabetic information includes for example but not limited by film code, DX code, and the digits, the brand and the marks printed on the film. Logic judgments regarding the type and the disposition of the scan film are made according to the alphabetic information. The sensing element may also sense other information of the film, such as the primary color of the film, through the information window for the future function augmentation.

The guiding portion of the embodiments of the invention could be made from metal or plastics. The guiding portion may be fixed on the input portion or integrally formed in one piece with the input portion.

The film holder of the embodiments of the invention could also be used for carrying other to-be-scanned objects such as a film with a positive, and the invention is not limited thereto.

The embodiments of the invention effectively augment the optical recognition function of the scanning device, avoid the film from being scratched, keep the quality of image scanning from being deteriorated and increase the convenience of use of the scanning device.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A film holder for carrying a to-be-scanned object, the to-be-scanned object having an image region and two side regions, wherein during scanning of the to-be-scanned object, the film holder is inserted into a scanning device, the film holder comprising:
an input portion having an entrance, a channel and an exit, the channel disposed between the entrance and the exit, wherein during scanning of the to-be-scanned object, the to-be-scanned object passes through the channel;
a guiding portion connecting to the input portion for guiding the to-be-scanned object; and
an information window formed at and through the guiding portion, wherein during scanning of the to-be-scanned object, the side regions of the to-be-scanned object pass through the information window.

2. The film holder according to claim 1, wherein the information window comprises a via hole intersecting with the guiding portion.

3. The film holder according to claim 2, wherein the via hole is a closed hole disposed in the guiding portion.

4. The film holder according to claim 2, wherein the via hole is a semi-closed hole disposed on one side of the guiding portion.

5. The film holder according to claim 2, wherein the via hole is anyone of a circle, an ellipse, a rectangle and a trapezoid or a combination thereof.

6. The film holder according to claim 1, wherein a slide boosting coating is formed on the guiding portion.

7. The film holder according to claim 1, wherein:
the guiding portion comprises two opposite guiding slots;
the side regions of the to-be-scanned object are received in the two guiding slots, respective;
the image region of the to-be-scanned object is located between the two guiding slots; and
the guiding slots and the channel are interconnected.

8. The film holder according to claim 1, wherein:
the input portion comprises an incoming surface and an upper cover; and
the incoming surface is disposed at the entrance and further extended to the channel, the channel surrounded by the upper cover and the incoming surface.

9. The film holder according to claim 8, wherein:
the input portion further comprises a protrusion disposed on the upper cover; and
when the film holder is inserted into the scanning device, the protrusion leans against the scanning device.

10. The film holder according to claim 1, further comprising:
a blocker disposed at one end of the guiding portion far away from the input portion;
the blocker has a bevel; and
when the film holder is inserted into the scanning device, the bevel leans against the scanning device.
